(19) United States
(12) Patent Application Publication
(10) Pub. No.: US 2008/0164295 A1
(43) Pub. Date: Jul. 10, 2008

(54) Break Mechanism for Empty Nail Gun

(76) Inventors: Yi Tseng Wu, Bali Shiang (TW); Ming Tsang Jiang, Bali Shiang (TW)

Correspondence Address: Wen-Chin Hu, 4331 Stevens Battle Lane, Fairfax, VA, 22033, US

(21) Appl. No.: 11/620,791

(22) Filed: Jan. 8, 2007

(51) Int. Cl. B27F 7/02

(52) U.S. Cl. 227/8

(57) ABSTRACT

An exemplary break mechanism is sued for a nail gun having a security slide rod, a magazine, a hitting slot configured for containing a signal nail, a nail guiding track disposed between the hitting slot and the magazine, the nail guiding track being capable of guiding a plurality of chain of nails into the hitting shot one by one, a side cover configured for covering the nail guiding track. The break mechanism includes an elastic member disposed between the break member and the side cover, the elastic member is configured to drive the break member to swing towards the hitting slot and the nail guiding track; and a break member having a detection portion and a block member. The detection portion is capable of detecting push action of a single nail in the hitting slot and the nail in the nail guiding track adjacent to the nail in the hitting slot. When the break member is pushed by the nail in the hitting slot or the adjacent nail in the nail guiding track, the block member releases the security slide rod. When the break member is released by a last nail in the hitting slot, the block member brakes the security slide rod. The nail gun used the break mechanism has a high reliability.

### BACKGROUND

The present invention relates to break mechanisms, and more particularly to a swing type break mechanism for a nail gun.

In general, a break mechanism is used in a nail gun for automatically detecting the status of a hitting slot of the nail gun. When the hitting slot of the nail gun is empty, the break mechanism can invalidate a trigger of the nail gun and remind the operator to supply the nails.

As shown in U.S. Pat. No. 6,966,476, a conventional nail gun with a break mechanism is disclosed, which includes a break member having a sensor and a block member disposed on the nail gun. The sensor is used for holding and detecting the nails in the hitting slot, and the block member is used for breaking or releasing the displacement of the security slide rod of the nail gun. With this configuration, when the last nail is driven, the break member brakes the security slide rod to move upwardly so as to break the displacement thereof for remaining the operator to resupply the nails.

When the nails in the magazine are used up, the operator may open the side cover and resupply a chain of nails firstly. Then the operator can draw the chain of nails in the magazine, so as to guide the first nail of the chain of nails into the hitting slot via placing the chain of nails along the track connected with the hitting slot. After that, close the side cover, the sensor of the break member may detect the first nail in the hitting slot and enable the operator to press on the trigger for hitting the first nail. The chain of nails can be guided into the hitting slot one by one by pressing on the trigger of the nail gun.

However, the operator is used to dispose the first nail of the chain of nails at the track adjacent to the hitting slot, and the first nail is guided into the hitting slot via being pushed by the claw of the track during the process of pressing on and releasing the trigger. That is, it needs the operator to press on the trigger to emptily actuate at least once, so as to guide the first nail into the hitting slot. Whereas, the sensor of the break member does not provide a reference end surface for detecting at least two nails at the same time. When the chain of nails is just resupplied and there is no nail in the hitting slot, the sensor can only detects the first nail that is adjacent to the hitting slot. Then, the displacement of the block member of the break member is liable to be insufficient, so that the security slide rod for breaking the trigger is not reliably released. This phenomenon will impact the reliability of the utilization of the nail gun, particularly when the nail gun is used for a long time and the joint portions of the members are wearing.

Accordingly, what is needed is a break mechanism for a nail gun that can overcome the above-described deficiencies.

### BRIEF SUMMARY

An exemplary break mechanism for a nail gun can assuredly detect the status of the nails contained in the hitting slot and the nail guiding track, then the operator is able to press on the trigger to emptily hitting the nail once to drive the nail into the hitting slot when the nails are just placed in the nail guiding track adjacent to the hitting slot.

The break mechanism for a nail gun having a security slide rod, a magazine, a hitting slot configured for containing a signal nail, a nail guiding track disposed between the hitting slot and the magazine, the nail guiding track being capable of guiding a plurality of chain of nails into the hitting shot one by one, a side cover configured for covering the nail guiding track, the break mechanism includes a break member arranged beside the nail guiding track and the hitting slot, the break member includes a detection portion and a block member; and an elastic member disposed between the break member and the side cover, the elastic member is configured to drive the break member to swing towards the hitting slot and the nail guiding track. The detection portion includes a reference end surface, and the reference end surface is capable of detecting a single nail in the hitting slot and the actions of pushing and releasing relative to at least one nail in the nail guiding track adjacent to the nail in the hitting slot. When the break member is pushed by the nail in the hitting slot or the adjacent nail in the nail guiding track, the block member releases the security slide rod; when the break member is released by a last nail in the hitting slot or in the nail guiding track, the block member breaks the security slide rod.

With these configurations, the detection portion can detect at least two adjacent nails in the hitting slot and the nail guiding track. When the first nail is placed in the nail guiding track adjacent to the hitting slot, the first nail can push the detection portion of the break member, so as to drive the block member of the break member to the position for releasing the security slide rod. At this moment, the operator is able to press on the trigger to emptily hitting the nail once to drive the first nail into the hitting slot, which improves the reliability of the nail gun.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded, perspective view of a break mechanism for a nail gun according to a first embodiment of the present invention;

FIG. 2 is a perspective, partly cross-sectional view the break mechanism of FIG. 1;

FIG. 3 is a front view of the break mechanism of FIG. 2;

FIG. 4 is a side, partly cross-sectional view of the break mechanism of FIG. 3;

FIG. 5 is a top, cross-sectional view of the break mechanism of FIG. 1, showing the operation process thereof;

FIG. 6 is another top, cross-sectional view of the break mechanism of FIG. 1, showing the operation process thereof;

FIG. 7 is further another top, cross-sectional view of the break mechanism of FIG. 1, showing the operation process thereof;

FIG. 8 is a front view of the break mechanism of FIG. 7;

FIG. 9 is an exploded, perspective view of a break mechanism for a nail gun according to a second embodiment of the present invention;

FIG. 10 is a perspective, partly cross-sectional view the break mechanism of FIG. 9;

FIG. 11 is a front, partly cross-sectional view of the break mechanism of FIG. 10;

FIG. 12 is a top, cross-sectional view of the break mechanism of FIG. 9, showing the operation process thereof;

FIG. 13 is another top, cross-sectional view of the break mechanism of FIG. 9, showing the operation process thereof;

FIG. 14 is further another top, cross-sectional view of the break mechanism of FIG. 9, showing the operation process thereof; and

FIG. 15 is a front, partly cross-sectional view of the break mechanism of FIG. 14.

### DETAILED DESCRIPTION

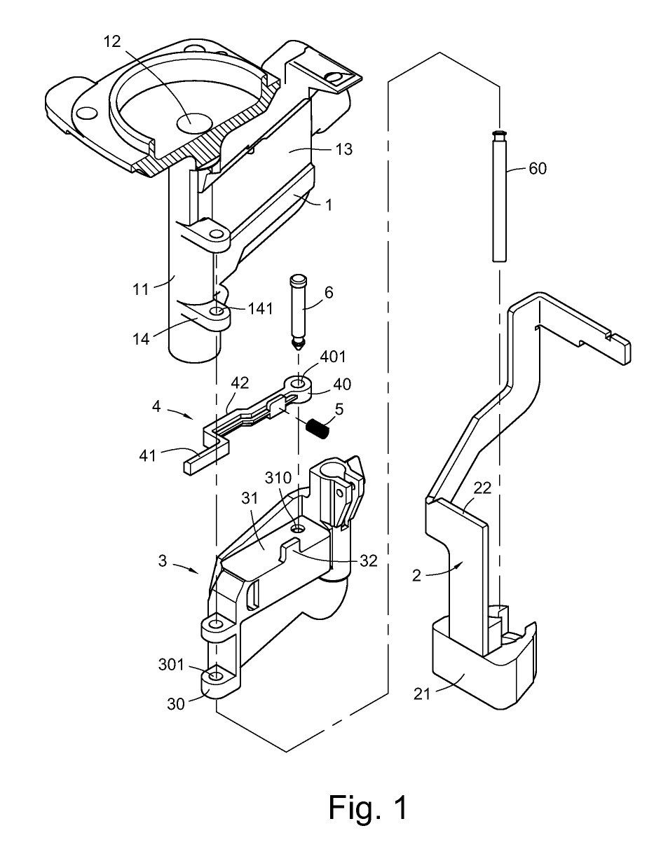

Referring to FIG. 1, an exploded, perspective view of a break mechanism for a nail gun according to a first embodiment of the present invention is shown. The nail gun includes a security slide rod 2 and a magazine for containing the nails.

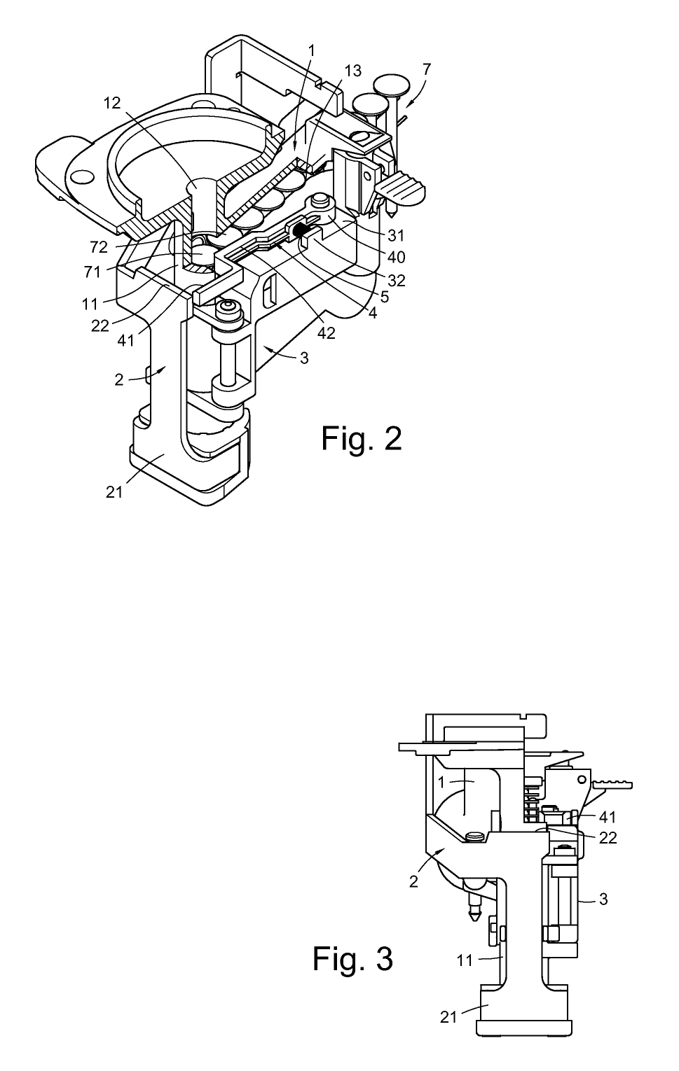

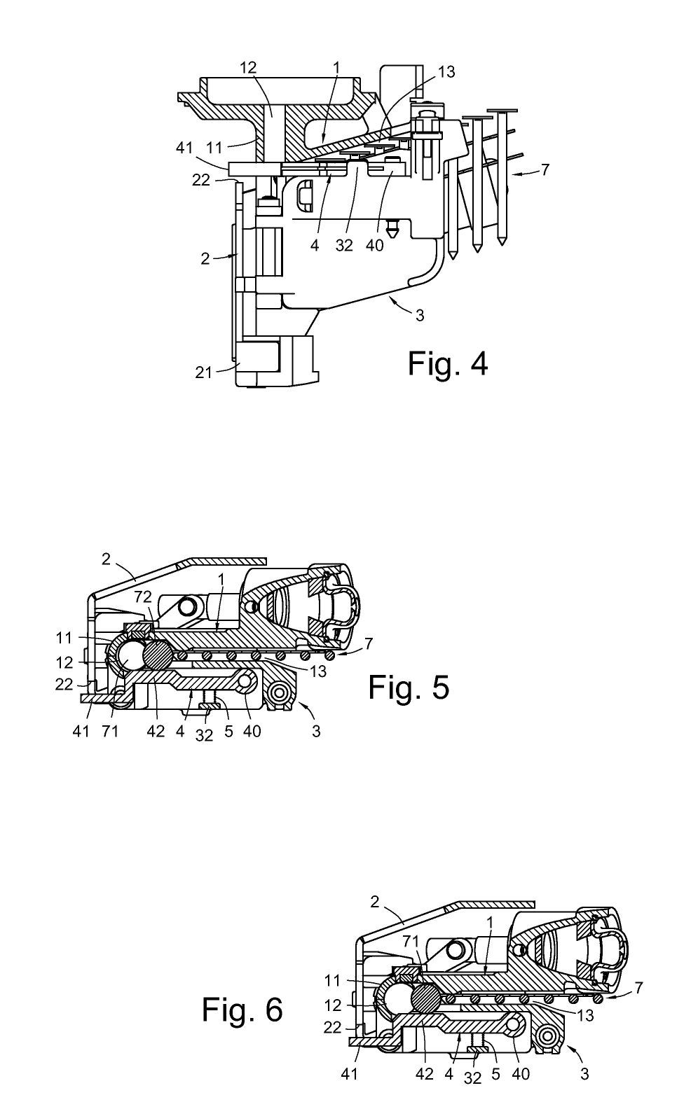

The nail gun further includes a sleeve base 1 and a hitting sleeve 11 (as shown in FIGS. 2, 3 and 4) disposed on the sleeve base 1. The hitting sleeve 11 includes a hitting slot 12 therein for containing a single nail to be driven. Moreover, a nail guiding track 13 is disposed between one end of the hitting slot 12 and the magazine contains a plurality of chained shaped nails 7, for guiding the nails into the hitting slot 12 one by one.

A side cover 3 is pivotally disposed at the sleeve base 1, which is capable of opening or closing the hitting slot 12 and the nail guiding track 13. The sleeve base 1 further includes two ear portions 14 having an axis hole 141, respectively. The side cover 3 also includes two ear portions 30 having an axis hole 301, respectively. An axis rod 60 prongs the ear portions 14 of the sleeve base 1 and 30 of the side cover 3, so as to pivotally fix the side cover 3 to the sleeve base 1.

The security slide rod 2 is slidely disposed at an outside of the sleeve base 1. One end of the security slide rod 2 extends to an export of the hitting slot 12 to form a hitting head 21 at a bottom portion of the sleeve base 1, for contacting the surface of the work piece. Another end of the security slide rod 2 extends to the position that is capable of pushing a reed in a trigger for driving the valve rod to firing position. Moreover, the security slide rod 2 includes a push portion 22 formed at a middle bended portion thereof adjacent to the end portion of the hitting sleeve 11.

The break mechanism mainly includes a break member 4 and an elastic member 5.

The break member 4 is pivotally disposed at a side of the nail guiding track 13 and the hitting slot 12. In the illustrated embodiment, one end of the break member 4 forms a pivot portion 40, and another end of the break member 4 forms a block member 41. The pivot portion 40 includes an axis hole 401 and an axis rod 6 disposed therein, which is also pivotally coupled to the axis hole 310 of an end surface 31 of the side cover 3. The block member 41 can break or release the push portion 22 of the security slide rod 2 via swing along the break member 4. Furthermore, the break member 4 includes a detection portion 42 formed between the pivot portion 40 and the block member 41. The detection portion includes a reference end surface, preferred having a plane shaped, which is capable of detecting the push action of the single nail in the hitting slot 12 and at least one nail in the nail guiding track 13 adjacent to the nail in the hitting slot 12, for driving the break member 4 to swing.

The elastic member 5 can be a spring, or the like, which is disposed between the break member 4 and the side cover 3. In this illustrated embodiment, the elastic member 5 is disposed between the break member 4 and a block 32 of the side cover 3, which is configured to drive the break member 4 to swing towards the hitting slot 12 and the nail guiding track 13.

In operation, when the operator places the chain of nails 7 along the nail guiding track 13 (as shown in FIG. 2) and guides the first nail 71 of the chain of nails 7 into the hitting slot 12 exactly, the elastic member 5 can drive the break member 4 to swing towards the hitting slot 12 and the nail guiding track 13, so as to make the detection portion 42 of the break member 4 capable of detecting the push action of the head of the first nail 71 in the hitting slot 12 and the head of a second nail 72 in the nail guiding track 13 adjacent to the first nail 71 (as shown in FIG. 5). At this moment, the force pressed on the break member 4 by the first and second nails 71, 72 is greater than that of the elastic member 5, and then the break member 4 is driven by the first and second nails 71, 72 to swing towards a direction away from the hitting slot 12 and the nail guiding track 13. The block member 41 of the break member 4 moves away from the upwardly moving passage of the push portion 22 of the security slide rod 2 (as shown in FIGS. 3, 5) to release the push portion 22, so as to let the security slide rod 2 upwardly move to push the reed in the trigger. Therefore, the operator can press on the trigger to drive the valve rod for actuating the first nail 71.

When the operator is used to fail to guide the first nail 71 into the hitting slot 12, and the first nail 71 is just placed in the nail guiding track 13 adjacent to the hitting slot 12 (as shown in FIG. 6), the detection portion 42 of the break member 4 still can detect the push action of the head of the first nail 71, so as to drive break member 4 to swing away from the hitting slot 12 and the nail guiding track 13. That is, the block member 41 moves away from the upwardly moving passage of the push portion 22 of the security slide rod 2 (shown in FIG. 3). In other words, when the nail 71 is disposed in the nail guiding track 13 adjacent to the hitting slot 12, the break member 4 can detects the nail 71, and swings to the position for releasing the security slide rod 2, so as to let the security slide rod 2 upwardly move to push the reed in the trigger. Then, the operator can press on the trigger to emptily hitting the nail once to drive the nail 71 into the hitting slot 12. With this configuration, the break member 4 has a broad detecting scope and high reliability, which improves the facility of supplying chain of nails 7 and prevents the break member 4 from being invalid due to the usage of the operator.

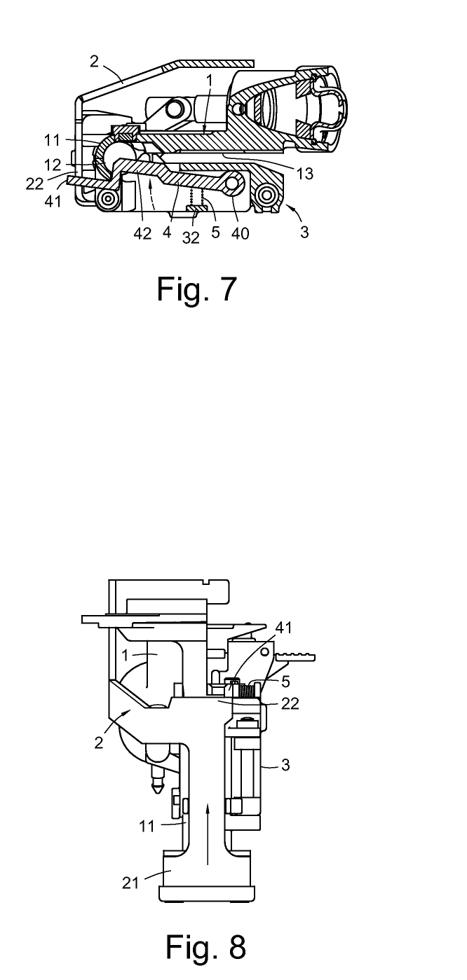

When the last nail in the hitting slot 12 is driven (as shown in FIGS. 7, 8), and the nails in the nail guiding track 13 are used up, the break member 4 can not detect the nails 7 contained in the hitting slot 12 or the nail guiding track 13. Therefore, the break member 4 is pressed by the elastic member 5 to swing towards the hitting slot 12 and the nail guiding track 13 for making the block member 41 to block the upwardly moving passage of the push portion 22. In this circumstance, if the operator pushes the hitting head 21 of the security slide rod 2 to abut the surface of the work piece, the block member 41 can prevent the push portion 22 from upwardly moving. That is, the security slide rod 2 cannot moves up to push the reed in the trigger. Therefore, the operator cannot drive the trigger of the nail gun validly, which compulsively reminds the operator to resupply the chain of nails 7.

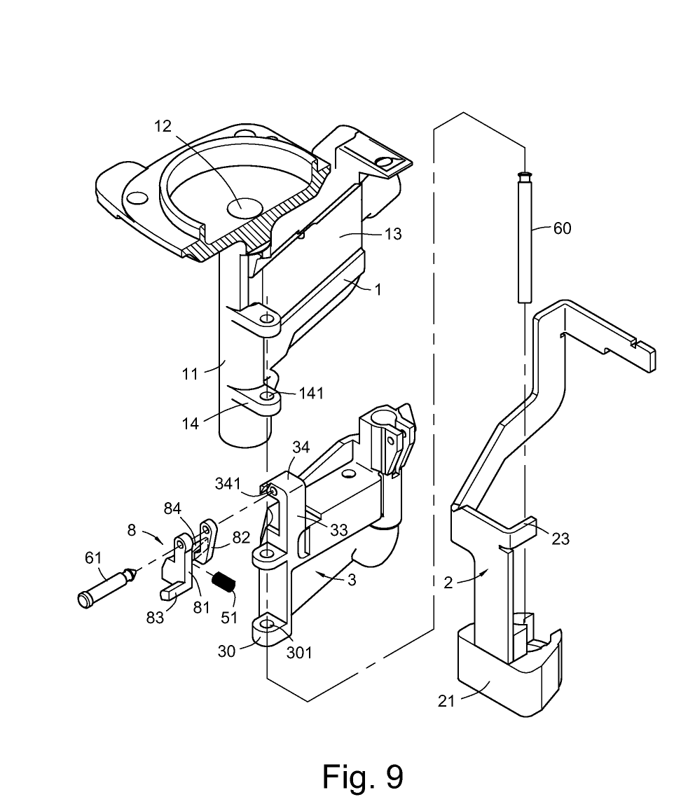

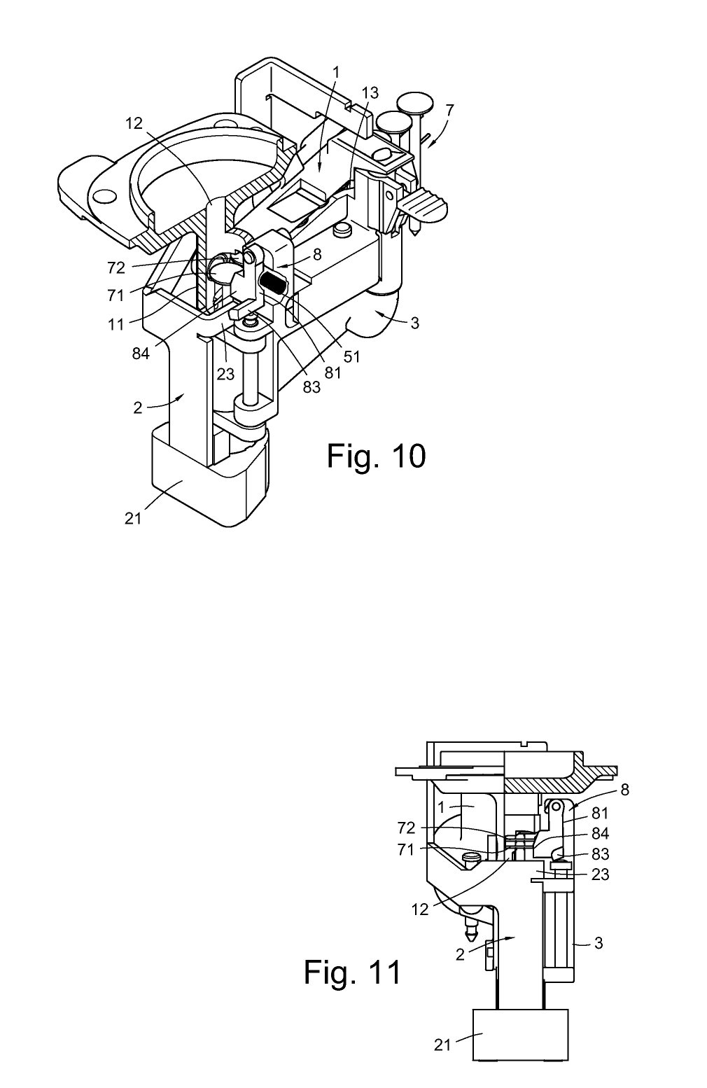

Referring to FIG. 9, an exploded, perspective view of a break mechanism for a nail gun according to a second embodiment of the present invention is shown. The side cover 3 includes a block 33, a pivot base 34 extended from the block 33, and a break member 8. The pivot base 34 includes an axis hole 341, and the break member 8 includes at least one swing arm pivotally coupled to the axis hole 341. In this illustrated embodiment, the break member 8 includes a first swing arm 81 and a second swing arm 82 parallel to the first swing arm 81, and a axis rod 61 prongs the first and second swing arms 81, 82, and is pivotally coupled to the axis hole 341 of the pivot base 34 (as shown in FIGS. 10, 11 and 12). The first swing arm 81 forms a block member 83 at a side portion of an end thereof, which is capable of breaking or releasing the push portion 23 of the security slide rod 2 via swing along the break member 8. A detection portion 84 is formed between the first and second swing arms 81 and 82, and the detection portion 84 is similar to the detection portion 42 (as shown in FIG. 1). The detection portion 84 also includes a plane shaped reference end surface, which is capable of detecting the push action of the nail in the hitting slot 12 and the nail in the nail guiding track 13 adjacent to the nail in the hitting slot, so as to drive the break member 8 to swing. An elastic member 51 is disposed between the block 33 and the break member 8, and the elastic member 51 may be a spring, or the like. The elastic member 51 is configured to drive the break member 8 to swing towards the hitting slot 12 and the nail guiding track 13. The break mechanism according to the second embodiment includes the break member 8, the push portion 23, the elastic ember 51, the pivot base 34, and the block 33, which has structure similar to that of the break mechanism according to the first embodiment.

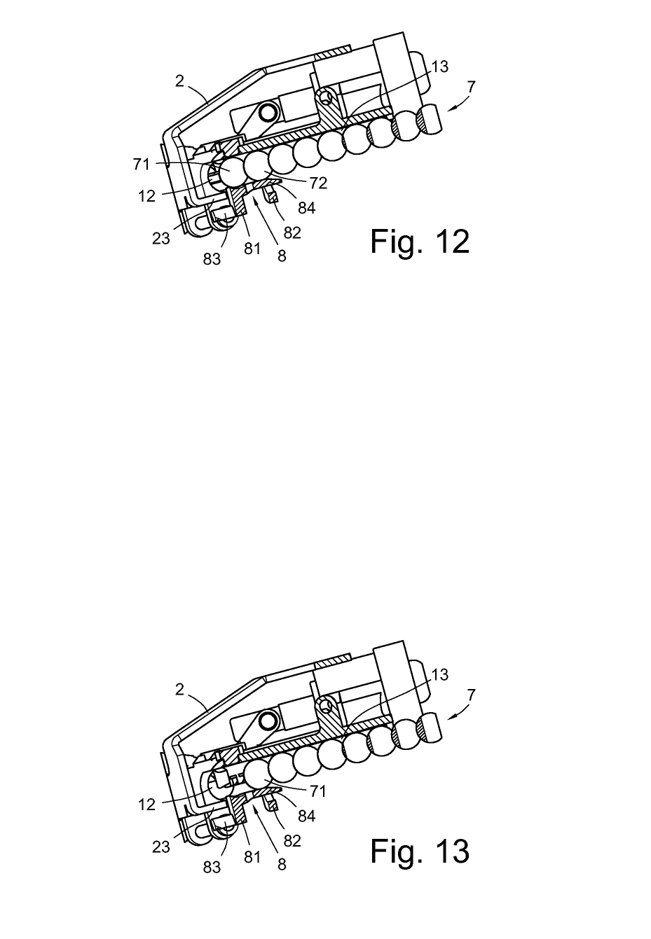

In operation, when the operator guides the first nail 71 of the chain of nails 7 into the hitting slot 12 exactly (as shown in FIGS. 10, 12), the elastic member 51 can drive the break member 8 to swing towards the hitting slot 12 and the nail guiding track 13, so as to make the detection portion 84 of the break member 8 capable of detecting the push action of the head of the first nail 71 in the hitting slot 12 and the head of a second nail 72 in the nail guiding track 13 adjacent to the first nail 71 (as shown in FIG. 11). At this moment, the break member 8 is driven by the first and second nails 71, 72 to swing towards a direction away from the hitting slot 12 and the nail guiding track 13. The block portion 83 of the first swing arm 81 moves away from the upwardly moving passage of the push portion 23 to release the push portion 23, so as to let the security slide rod 2 upwardly move to push the reed in the trigger. Therefore, the operator can press on the trigger to drive the valve rod for actuating the first nail 71.

When the operator is used to fail to guide the first nail 71 into the hitting slot 12, and the first nail 71 is just placed in the nail guiding track 13 adjacent to the hitting slot 12 (as shown in FIG. 13), the detection portion 82 of the break member 8 still can detect the push action of the head of the first nail 71, so as to drive break member 8 to swing away from the hitting slot 12 and the nail guiding track 13. That is, the block member 83 moves away from the upwardly moving passage of the push portion 23 for releasing the security slide rod 2, so as to let the security slide rod 2 upwardly move to push the reed in the trigger. Then, the operator can press on the trigger to emptily hitting the nail once to drive the nail 71 into the hitting slot 12.

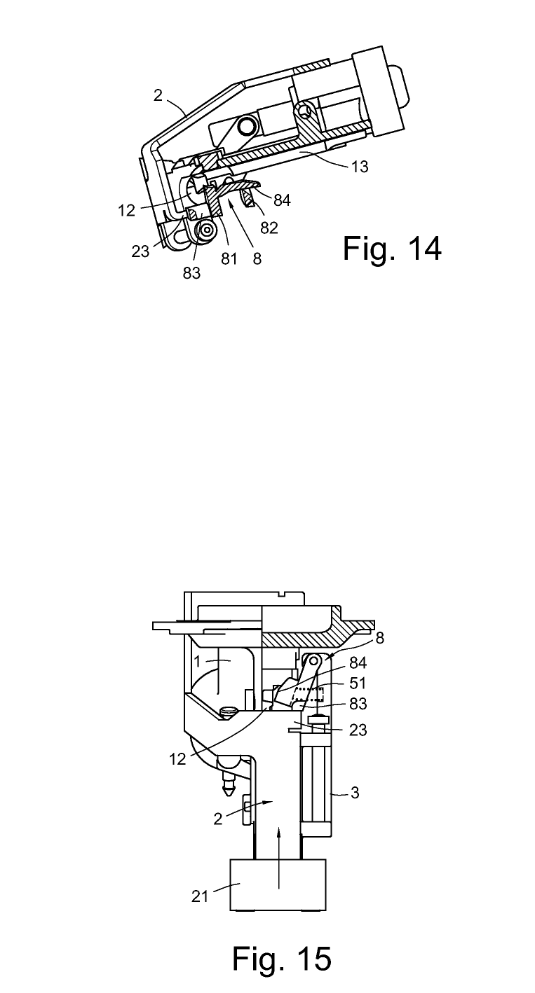

When the last nail in the hitting slot 12 is driven (as shown in FIGS. 14 and 15), and the nails in the nail guiding track 13 are used up, the detection portion 84 can not detect the chain of the nails 7 contained in the hitting slot 12 or the nail guiding track 13. Therefore, the break member 8 is pressed by the elastic member 51 to swing towards the hitting slot 12 and the nail guiding track 13 for making the block member 82 to block the upwardly moving passage of the push portion 23. That is, the security slide rod 2 cannot moves up to push the reed in the trigger. Therefore, the operator cannot drive the trigger of the nail gun validly, which compulsively reminds the operator to resupply the chain of nails 7.

With these above-mentioned configurations, the break member 4 and 8 can help to detect the status of the nails contained in the hitting slot 12 or the nail guiding track 13. Even if the operator can not resupply the chain of nails 7 exactly, it can detect the nails 7 in the nail guiding track 13 adjacent to the hitting slot 12. Therefore, it only needs the operator pressing on the trigger to emptily actuate and then the chain of nails 7 can be guided into the hitting slot.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

1. A break mechanism for a nail gun having a security slide rod, a magazine, a hitting slot configured for containing a single nail, a nail guiding track disposed between the hitting slot and the magazine, the nail guiding track being capable of guiding a chain of nails into the hitting shot one by one, a side cover configured for covering the nail guiding track, the break mechanism comprising:
a break member arranged beside the nail guiding track and the hitting slot, the break member comprising a detection portion and a block member; and
an elastic member disposed between the break member and the side cover, the elastic member is configured to drive the break member to swing towards the hitting slot and the nail guiding track;
wherein the detection portion comprises a plane shaped reference end surface, the reference end surface is capable of detecting a nail next to be sent to the hitting slot in the nail guiding track, so that the break member is stopped by the next nail in the nail guiding track to have the block member release the security slide rod when there is no nail in the hitting slot; only until a last single nail in the hitting slot is gone, the break member is pushed by the elastic member to have the block member brake the security slide rod.

2. (canceled)

3. The break mechanism as claimed in claim 1, wherein the elastic member is disposed at the side cover.

4. The break mechanism as claimed in claim 1, wherein the side cover includes a block thereat, and the elastic member is disposed between the block and the break member.

5. The break mechanism as claimed in claim 1, wherein the side cover forms an end surface, the break member pivotally coupled to the end surface.

6. The break mechanism as claimed in claim 1, wherein the side cover forms a base extended from thereof, and the break member pivotally coupled to the base.

7. The break mechanism as claimed in claim 1, wherein one end of the break member forms a pivotal portion pivotally coupled to the side cover, and the block member is disposed at another end of the break member, the detection portion is disposed between the pivotal portion and the block member.

8. The break mechanism as claimed in claim 1, wherein the break member includes at least one swing arm pivotally coupled to the side cover.

9. (canceled)

10. A break mechanism for a nail gun having a security slide rod, a magazine, a hitting slot configured for containing a single nail, a nail guiding track disposed between the hitting slot and the magazine, the nail guiding track being capable of guiding a chain of nails into the hitting shot one by one, a side cover configured for covering the nail guiding track, the break mechanism comprising: p1 a break member arranged beside the nail guiding track and the hitting slot, the break member comprising a detection portion, a block member and a pivot portion, the pivot portion having two parallel swing arms pivotally coupled to a protruding block of the side cover, the block member being extending out from one end of one swing arm, and the detection portion being disposed between the two swing arms; and
an elastic member disposed in the protruding block to push the break member to swing towards the hitting slot and the nail guiding track;
wherein the detection portion comprises a plane shaped reference surface, the reference surface is capable of detecting a nail next to be sent to the hitting slot in the nail guiding track, so that the break member is stopped by the next nail to have the block member release the security slide rod when there is no nail in the hitting slot; only until a last single nail in the hitting slot is gone, the break member is pushed by the elastic member to have the block member brake the security slide rod.
